(19) United States
(12) Patent Application Publication
(10) Pub. No.: US 2026/0210303 A1
(43) Pub. Date: Jul. 23, 2026

(54) DEACTIVATION MECHANISM AND ASSOCIATED VALVE EVENTS FOR DIVIDED EXHAUST BOOST (DEB) ENGINE

(71) Applicant: SAUDI ARABIAN OIL COMPANY, Dhahran (SA)

(72) Inventors: Praveen Kumar, New Hudson, MI (US); Andrew Baur, Whitmore Lake, MI (US)

(73) Assignee: ARAMCO SERVICES COMPANY, Houston, TX (US)

(21) Appl. No.: 19/033,272

(22) Filed: Jan. 21, 2025

(51) Int. Cl. F02D 13/02; F01L 1/344

(52) U.S. Cl. CPC F02D 13/0249; F01L 1/344

(57) ABSTRACT

An engine includes pistons, cylinders, a crankshaft, an intake manifold, an exhaust manifold, intake valves, exhaust valves, a fuel injector, and an Electronic Control Unit (ECU). The pistons actuate the crankshaft and are actuated by combustion reactions. Each cylinder houses a piston and contains a combustion reaction. The intake valves control a flow of a gas mixture to the cylinders. The fuel injector injects fuel into the cylinders that is combusted to create exhaust gases. The exhaust manifold includes a blowdown line and a scavenge line that deliver to a turbine and a catalytic conversion device, respectively. Each exhaust valve is disposed at a blowdown or scavenge line inlet and controls a flow of the exhaust gases to the exhaust manifold. The ECU deactivates exhaust valves associated with the blowdown line inlets when the engine operates with a Brake Mean Effective Pressure (BMEP) value less than a BMEP threshold.

### BACKGROUND

Gasoline Spark-Ignited (SI) engines are subject to emissions requirements by various regulatory agencies. One concept for addressing the aforementioned emissions requirements is a Divided Exhaust Boost (DEB) manifold, which decouples Blowdown (BD) and Scavenge (SC) processes. However, DEB manifolds are known to experience difficulties delivering torque at low engine speeds due to exhaust enthalpy losses at an inlet of a turbocharger. Thus, it is desirable for a DEB engine to provide adequate torque delivery at low engine speeds while retaining compliance with emissions requirements.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

An engine includes pistons, cylinders, a crankshaft, an intake manifold, an exhaust manifold, intake valves, exhaust valves, at least one fuel injector, and an Electronic Control Unit (ECU). The pistons are actuated by combustion reactions, and the combustion reactions create exhaust gases. Each cylinder houses a corresponding piston and forms a containment boundary for a corresponding combustion reaction. The crankshaft is actuated by the pistons. The intake manifold supplies a gas mixture to the cylinders. The intake valves collectively control a flow rate of the gas mixture from the intake manifold to the cylinders. The fuel injector injects fuel into the cylinders, and the fuel is combined with the gas mixture to form a fuel mixture that is combusted during the corresponding combustion reaction. The exhaust manifold includes a blowdown line and a scavenge line. The blowdown line includes blowdown line inlets that receive a first portion of the exhaust gases from the cylinders and deliver the first portion of the exhaust gases to a turbine actuated by the exhaust gases. The scavenge line includes scavenge line inlets that receive a second portion of the exhaust gases from the cylinders and deliver the second portion of the exhaust gases to a catalytic conversion device. The exhaust valves control a flow rate of the exhaust gases passing from the cylinders to the exhaust manifold. Each exhaust valve is disposed at an associated blowdown line inlet or at an associated scavenge line inlet. The ECU coordinates operations of the intake valves and the exhaust valves such that the exhaust valves associated with the blowdown line inlets are deactivated when the engine operates with a Brake Mean Effective Pressure (BMEP) value that is less than a first predetermined BMEP threshold.

A method includes supplying a gas mixture to cylinders with an intake manifold. The method also includes controlling a flow rate of the gas mixture from the intake manifold to a corresponding cylinder with intake valves. Fuel is injected into the cylinders with at least one fuel injector. The fuel is combined with the gas mixture to form a fuel mixture that is combusted in a corresponding cylinder during a corresponding combustion reaction, where the combustion of the fuel mixture creates exhaust gases. Each combustion reaction is contained in a corresponding cylinder of the plurality of cylinders. Each cylinder houses a corresponding piston and forms a containment boundary for the corresponding combustion reaction. The pistons are actuated with the combustion reactions, and the pistons actuate a crankshaft. A first portion of the exhaust gases is received from the plurality of cylinders with blowdown line inlets of a blowdown line of an exhaust manifold. The first portion of the exhaust gases is delivered to a turbine that is actuated by the exhaust gases. A second portion of the exhaust gases is received from the cylinders and delivered to a catalytic conversion device with scavenge line inlets of a scavenge line of the exhaust manifold. A flow rate of the exhaust gases from the cylinders to the exhaust manifold is controlled with exhaust valves, and each exhaust valve is disposed at an associated blowdown line inlet or at an associated scavenge line inlet. The operations of the intake valves and the exhaust valves are coordinated by an Electronic Control Unit (ECU) such that the exhaust valves associated with the blowdown line inlets are deactivated when an engine comprising the intake valves and the exhaust valves operates with a Brake Mean Effective Pressure (BMEP) value that is less than a first predetermined BMEP threshold.

Any combinations of the various embodiments and implementations disclosed herein can be used in a further embodiment, consistent with the disclosure. Other aspects and advantages of the claimed subject matter will be apparent from the following description and the appended claims.

### BRIEF DESCRIPTION OF DRAWINGS

FIG. 1 depicts a Divided Exhaust Boost (DEB) engine in accordance with one or more embodiments disclosed herein.

FIGS. 2A-2D depict phases of an engine cycle in accordance with one or more embodiments disclosed herein.

FIG. 3 depicts an operating curve of an engine in accordance with one or more embodiments disclosed herein.

FIGS. 4A-4D depict engine timing profiles in accordance with one or more embodiments disclosed herein.

FIG. 5 is a chart summarizing engine timing profiles in accordance with one or more embodiments disclosed herein.

FIG. 6 depicts a valvetrain system in accordance with one or more embodiments disclosed herein.

FIGS. 7A and 7B depict a valvetrain assembly in accordance with one or more embodiments disclosed herein.

FIGS. 8A and 8B depict a two-step Roller Finger Follower (RFF) in accordance with one or more embodiments disclosed herein.

FIG. 9 depicts a block diagram of an engine in accordance with one or more embodiments disclosed herein.

FIG. 10 depicts a method for operating an engine in accordance with one or more embodiments disclosed herein.

### DETAILED DESCRIPTION

Specific embodiments of the disclosure will now be described in detail with reference to the accompanying figures. In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well known features have not been described in detail to avoid unnecessarily complicating the description.

Throughout the application, ordinal numbers (e.g.,, first, second, third, etc.) may be used as an adjective for an element (i.e., any noun in the application). The use of ordinal numbers is not intended to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In addition, throughout the application, the terms “upper” and “lower” may be used to describe the position of an element of the invention. In this respect, the term “upper” denotes an element disposed above a corresponding “lower” element in a vertical direction, while the term “lower” conversely describes an element disposed below a corresponding “upper” element in the vertical direction. Similarly, the term “inner” refers to an orientation closer to a center of an object than a corresponding “outer” orientation.

In one aspect, embodiments disclosed herein relate to extended Blowdown (BD) and Scavenge (SC) valve events integrated with a two-step valve deactivation mechanism of a DEB engine. Such embodiments allow for further increase in exhaust enthalpy for a turbine when an SC valve is deactivated. In turn, the increase in exhaust enthalpy leads to a higher turbine work and boost pressure, leading to more efficient combustion. In addition, and as discussed further below, exhaust gases are routed towards the catalyst with a high temperature while a BD event is deactivated. The increased exhaust gas temperature further results in improvements in the catalytic conversion process, leading to reduced emissions levels overall.

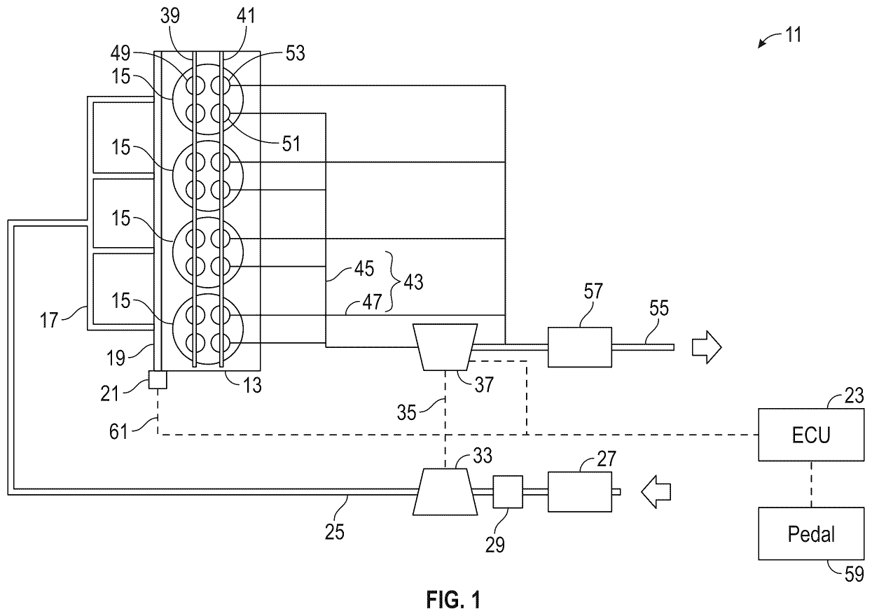

Turning to FIG. 1, FIG. 1 depicts an engine 11 in accordance with one or more embodiments of the invention as described herein. It will be appreciated by a person skilled in the art that FIG. 1 is merely one example of hardware components of an engine, and the design thereof may be modified to suit various real world constraints such as size, cost, component availability, and similar considerations. Thus, FIG. 1 is not intended to limit the particular structure or functionality of an engine. Furthermore, details of the engine 11 that would be appreciated by a skilled person as being routine or superfluous have been omitted where appropriate in order to aid in the brevity of this disclosure.

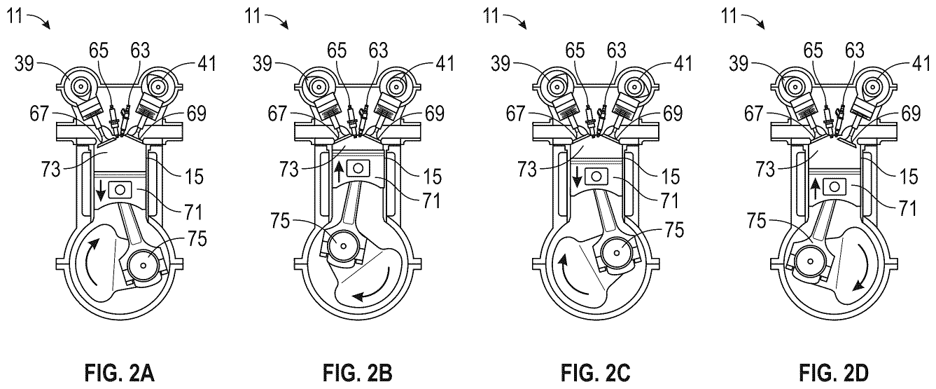

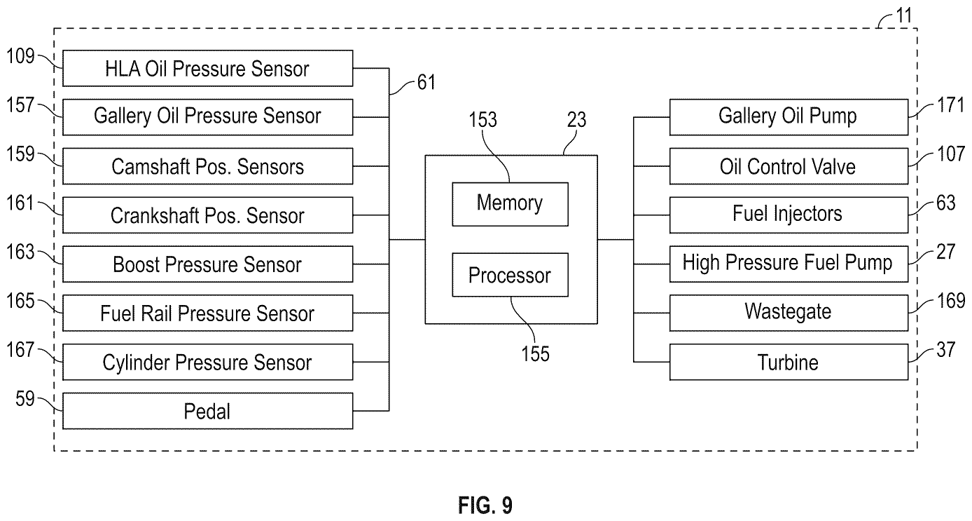

The central component of the engine 11 is the engine block 13, which provides a casing structure for mounting various other components of the engine 11 thereto. Typically, the engine block 13 is cast from aluminum or iron, and may be cast in upper and lower pieces (not shown). Components such as cylinder head (not shown) that contains a camshaft (e.g., FIG. 2A) are typically attached to the top of the engine block 13, where the cylinder head (not shown) is sealed with gaskets (not shown) and a head cover (not shown) to form a fluidly sealed structure. Similarly, an oil pan (not shown) and a main gallery oil pump (e.g., FIG. 9) are typically positioned below the engine block 13, and are also sealed thereto with gaskets (not shown). As a whole and as discussed further below, the engine block 13 and components connected thereto serve to generate a combustion reaction in a contained manner such that the combustion reaction ultimately generates power via a crankshaft (e.g., FIG. 2A).

The aforementioned combustion reaction is contained in cylinders 15, which are bores formed during the process of casting the engine block 13. As shown in FIG. 1, the engine 11 as a whole includes four cylinders positioned in a linear fashion, which is commonly referred to as an “inline-four,” “straight-four,” or “I-4” engine. As is commonly known in the art, an engine 11 may be configured with any number of cylinders, with non-limiting examples including four, six, eight, or twelve cylinders disposed in various inline or “V” configurations. Each cylinder 15 is sized and shaped to form a containment boundary for a corresponding combustion reaction. The timing and generation of the combustion reaction within each cylinder 15 is further discussed below. As a whole, the combustion reaction of each cylinder 15 is timed such that the combustion reactions occur in sequence.

The combustion reaction is generated by igniting fuel mixtures in each of the cylinders 15, the process of which is further depicted in FIGS. 2A-2D. The fuel mixture includes fuel injected into the cylinders 15 and air received from an intake manifold 17. The fuel portion of the fuel mixture is sprayed into the cylinders 15 by way of a fuel rail 19, which includes a plurality of fuel injectors (e.g., FIG. 2A) and a high-pressure fuel pump 21. The fuel rail 19 is formed as a hollow metal tube that receives fuel from a storage container such as a fuel tank (not shown). Fuel is pressurized by way of the high-pressure fuel pump 21, which may be embodied as a centrifugal or a positive displacement pump. The high-pressure fuel pump 21 features a variable geometry inlet valve (not shown) that is controlled by an Engine Control Unit (ECU) 23 as discussed below to regulate pressure in the fuel rail 19. In this regard, a pressure sensor (not shown) located on the fuel rail 19 senses rail pressure for feedback control by the ECU 23.

On the other hand, the air portion of the fuel mixture is received from the air intake line 25. The air intake line 25 is open at one end to receive air from an external environment of the engine 11, and is typically formed of a flexible plastic hose. The open end of the air intake line 25 includes an air filter 27 that serves to remove large particulate matter from the intake air stream. The air filter 27 may be disposed in a separate housing that is connected in-line with the air intake line 25 with hose clamps, for example.

Downstream of the air filter 27 and also in line with the air intake line 25, a Mass Air Flow (MAF) sensor 29 is positioned to capture the amount of air flowing into the engine 11 as a whole. The MAF sensor 29 is further discussed below in relation to FIG. 9. The air is compressed by a compressor 33, which is formed as a wheel with blades that serve to accelerate the volume of air flowing therethrough. The compressor 33 is connected by way of a shaft 35 to a turbine 37, which is a blade-ridden wheel that is actuated by exhaust gases of the combustion reaction. In this way, the exhaust gases generated by the engine 11 serve to compress a flow of air used to generate a subsequent combustion reaction in a cyclic process.

Collectively, the compressor 33 and the turbine 37 form a Variable Geometry Turbocharger (VGT). As will be appreciated by a person skilled in the art, a Variable Geometry Turbocharger may include a sliding nozzle or pivoting vane turbine, as well as a compressor that includes variable inlet guide vanes and/or variable geometry diffusers. Thus, the turbine 37 may be embodied as a sliding nozzle turbine or a pivoting vane turbine, or functional equivalents thereof. On the other hand, the compressor 33 may be embodied including variable inlet guide vanes and/or variable geometry diffusers, or functional equivalents thereof. In other embodiments, the engine 11 may include a fixed geometry turbocharger that has a wastegate (e.g., FIG. 9) to control exhaust gas pressure flowing through the turbine 37 without departing from the nature of this disclosure. By controlling the pivoting vanes (not shown) or the wastegate (e.g., FIG. 9), the rotation of the turbine 37 is controlled. Because the turbine 37 is rotationally connected to the compressor 33 by the shaft 35, the amount of air drawn into the engine 11 by the compressor 33 is a function of the rotation speed of the turbine 37. Thus, controlling the internal geometry of the turbine 37 also controls the volume of air present in future combustion reactions.

After passing through the compressor 33, the compressed air stream is passed to an intake manifold 17 and the cylinders 15. The intake manifold 17 partitions the compressed air stream from the air intake line 25 into distinct streams. The intake manifold 17 is formed as a plenum with one inlet and multiple outlets, where each outlet is fluidly connected to one of the cylinders 15. Thus, the intake manifold 17 serves to form multiple fluid passageways that connect the cylinders 15 to the air intake line 25 for purposes of receiving the compressed intake air stream in the cylinders 15. The cylinders 15 each include two intake ports 49, where each intake port 49 is an orifice that fluidly connects a corresponding branch of the intake manifold 17 to a corresponding cylinder 15. An intake valve (e.g., FIG. 2A) is positioned at each intake port 49 to control the flow of the compressed intake air stream into the cylinder 15. In general, the various valves described herein function to control the flow rate of gases through a corresponding port of the engine 11. Intake valves (e.g., FIG. 2A) collectively function to control a flow rate of the intake air stream from the intake manifold 17 to the cylinders 15, and exhaust valves (e.g., FIG. 2A) collectively function to control a flow rate of exhaust gases passing from the cylinders 15 to an exhaust manifold 43.

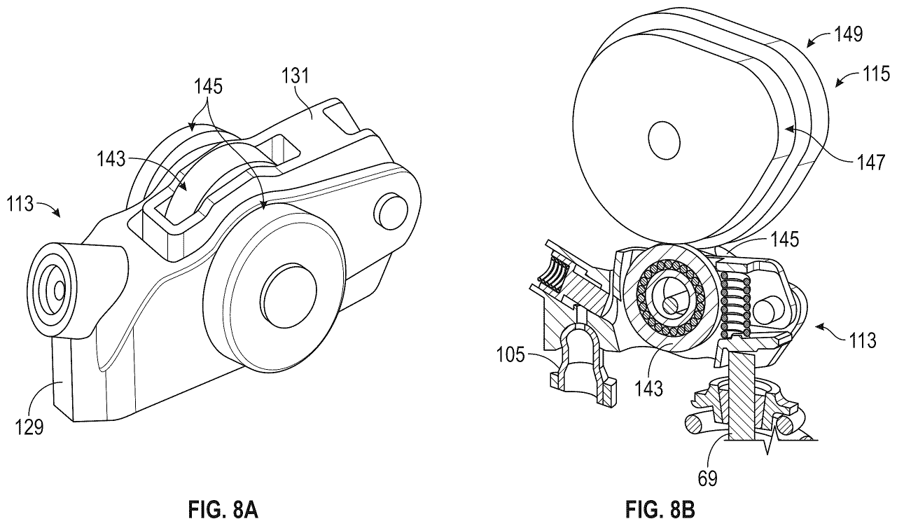

The engine 11 further includes an intake camshaft 39 and an exhaust camshaft 41. In general, the camshafts 39 and 41 are formed as metal rods that serve to mechanically control the operation of the engine 11 by regulating the introduction and removal of various fluids from the cylinders 15. The camshafts 39 and 41 are aligned so as to extend across each of the cylinders 15, such that a single intake camshaft 39 coordinates the intake operations and a single exhaust camshaft 41 facilitates the exhaust operations of the cylinders 15. Each camshaft includes a plurality of lobes (e.g., FIG. 8B) that actuate a corresponding valve (e.g., FIGS. 2A-2D) of a corresponding cylinder 15. In the context of FIG. 1, the intake camshaft 39 serves to control intake valves (e.g., FIGS. 2A-2D) that introduce the compressed air stream from the air intake line 25 into the cylinder 15. Similarly, the exhaust camshaft 41 serves to facilitate the actuation of the exhaust valves (e.g., FIGS. 2A-2D) that selectively pass exhaust gases formed by a combustion reaction from the cylinders 15 to the exhaust manifold 43.

The exhaust manifold 43 receives exhaust gases from the cylinders 15, and is formed as a Divided Exhaust Boost (DEB) manifold with multiple inlets and multiple outlets. The exhaust manifold 43 is broadly formed of two distinct sections. A first section of the exhaust manifold 43, denoted herein as a blowdown line 45, extends from each cylinder 15 to a turbine 37. The inlets of the blowdown line 45 are fluidly connected to the cylinders 15 by way of a plurality of blowdown ports 51. A second section of the exhaust manifold 43, denoted herein as a scavenge line 47, extends from each cylinder 15 to a catalytic conversion device 57 positioned downstream of the turbine 37. The inlets of the scavenge line 47 are fluidly connected to the cylinders 15 by way of a plurality of scavenge ports 53. Similar to the intake ports 49, the blowdown ports 51 and the scavenge ports 53 are formed as orifices that fluidly connect the cylinders 15 to the exhaust manifold 43. As discussed further below, exhaust valves (e.g., FIGS. 2A-2D) are positioned to control the flow of exhaust gases through the blowdown ports 51 and the scavenge ports 53.

The blowdown line 45 fluidly connects each cylinder 15 to a turbine 37. The turbine 37 is connected by a shaft 35 to the compressor 33 as noted above. Exhaust gases from the cylinder 15 are transferred by the blowdown line 45 to the turbine 37, where the exhaust gases actuate the turbine 37. The rotation of the turbine 37 rotates the compressor 33, which causes the compressor 33 to compress an intake air stream received by the air intake line 25.

After passing through the turbine 37 or exiting the scavenge line 47, the exhaust gases enter an exhaust pipe 55 that ultimately passes the exhaust gases to the external environment. That is, exhaust gases routed through the scavenge line 47 and exhaust gases routed through the blowdown line 45 are rejoined into a unified exhaust stream in the exhaust pipe 55. Prior to passing to the external environment, the unified exhaust stream is passed through a catalytic conversion device 57. The catalytic conversion device 57 includes a Three-Way Catalyst (TWC) that functions to convert pollutants into less harmful emissions. The TWC may include a substrate formed from a ceramic monolith and covered by a wash coat that acts as a carrier for a catalyst (e.g., Rhodium) that catalyzes the pollutants. In this regard, the TWC (and thus the catalytic conversion device 57) functions to reduce Nitrogen Oxides (NOx) into Nitrogen (N) and to oxidize Carbons (C), Hydrocarbons (HC), and Carbon Monoxide (CO) into Carbon Dioxide (CO₂). After exiting the catalytic conversion device 57, the exhaust gas is exhausted to the external environment by the exhaust pipe 55 as discussed above, which completes the combustion process.

The various functions of components of the engine 11 are coordinated by an Electronic Control Unit (ECU) 23. The ECU 23 is formed as one or more processors, integrated circuits, controllers, or a combination thereof that serve to execute computer readable instructions. The ECU 23 may include a memory (e.g., FIG. 9) and a processor (e.g., FIG. 9) that respectively serve to store and execute the computer readable instructions. The computer readable instructions include information regarding the conditions (i.e., timing, engine temperature, pressure, duration, etc.) for actuating a particular component of the engine 11, and are further discussed below. As shown in FIG. 1, the ECU 23 is connected to components of the engine 11 such as the high-pressure fuel pump 21, the turbine 37, and various other components by way of a wiring harness 61. For its part, the wiring harness 61 is formed as a plurality of wires that form electrical pathways for transmitting signals from the ECU 23 to the various components. The ECU 23 receives user input by way of an accelerator pedal 59, which may be embodied, for example, as a lever fixed to a potentiometer. The user input correlates to a request for additional torque, and the pedal 59 is also connected to the ECU 23 by way of the wiring harness 61.

Turning to FIGS. 2A-2D, FIGS. 2A-2D illustrate the four-step process followed by the engine 11 for creating a combustion reaction. Specifically, FIG. 2A relates to the intake phase of the combustion reaction, whereas FIG. 2B relates to the compression phase, FIG. 2C relates to the power phase, and FIG. 2D corresponds to the exhaust phase of the engine cycle. FIGS. 2A-2D each depict a point in time during the operation of a single cylinder 15, such that FIGS. 2A-2D will be replicated for each cylinder 15 per engine cycle.

As illustrated in FIG. 2A, the engine 11 includes a fuel injector 63, which is fluidly connected to the fuel rail 19. The fuel injector 63 is embodied, for example, as an electromagnetically actuated pintle valve that serves to selectively pass fuel from a storage container, such as a fuel tank (not shown), into a corresponding cylinder 15. The actuation of the fuel injector 63 is controlled by the ECU 23 as discussed further below. In addition, the ECU 23 coordinates the operation of each fuel injector 63 in tandem with the other fuel injectors 63 to form a cohesive operation that includes multiple combustion reactions occurring in quick succession.

The engine 11 further includes an intake camshaft 39 and an exhaust camshaft 41 as discussed above in relation to FIG. 1. Each camshaft includes a plurality of lobes (e.g., FIG. 8B) that actuate a corresponding valve of a corresponding cylinder 15. The corresponding valves include, for example, an intake valve 67 that actuates based on the motion of the intake camshaft 39 and an exhaust valve 69 that actuates based on the motion of the exhaust camshaft 41. In the context of FIGS. 2A-2D, the intake valve 67 serves to introduce a compressed air stream from the air intake line 25 into the cylinder 15. Similarly, the exhaust valve 69 serves to selectively pass exhaust gases formed by a completed combustion reaction from the cylinders 15 to the exhaust manifold 43. The intake valve 67 and the exhaust valve 69 may be formed, for example, from metal and are typically formed with a conical profile that is attached to a tappet. Such a valve is typically referred to as a “poppet” valve in the art.

Once air and fuel are delivered to the cylinder 15, the mixture, denoted herein as a “fuel mixture”, is combusted with a spark plug 65. The spark plug 65 is substantially formed by a central electrode and a ground electrode, which are separate by a precise gap. The spark plug 65 generates a high-voltage spark that ignites the fuel mixture. The ignited fuel mixture expands to generate power via a piston 71 as discussed further below, where the expansion of the combusting fuel mixture is succinctly denoted herein as a “combustion reaction” or a “combustion event”.

For its part, the cylinder 15 forms a containment boundary for the combustion reaction in conjunction with a piston 71 that is actuated by the combustion reaction. The usable volume within the containment boundary is depicted as a combustion chamber 73, which represents the volume in the engine 11 created by the piston 71 and the cylinder 15. The piston 71 is a solid body, typically formed of metal, that is thrust downwards by the combustion reaction. The piston 71 is mechanically coupled to a crankshaft 75, which performs multiple functions discussed below. As a first function, the crankshaft 75 serves to couple the combined actuation of the pistons 71 into a single motion, such that the crankshaft 75 forms a power output shaft of the engine 11. As a second function, the crankshaft 75 provides a point to measure output rotations of the engine 11, such that the position of the crankshaft 75 is related to the timing of operations of the engine 11 as a whole.

With the components of FIGS. 2A-2D discussed above, the below paragraphs related to FIGS. 2A-2D discuss time-dependent actions taken by various components of the engine 11 to create the combustion reaction. In relation to FIG. 2A specifically, the intake valve 67 is opened by the intake camshaft 39 to allow air to pass from the intake manifold 17 to the cylinder 15. This is further facilitated by the crankshaft 75 being actuated by other combustion reactions in other cylinders 15, causing the piston 71 of FIG. 2A to thrust downward and creating a negative pressure in the combustion chamber 73. Accordingly, FIG. 2A corresponds to the intake phase of a four stroke combustion process, as FIG. 2A depicts the air entering the cylinder 15. Fuel is also injected by way of the fuel injector 63 during the intake phase. The air and fuel are mixed to form a fuel mixture by the downward motion of the piston 71, which increases the available volume of the combustion chamber 73. Once the fuel mixture is disposed in the combustion chamber 73, the process continues as depicted in FIG. 2B.

In FIG. 2B, the piston 71 is forced upwards by the crankshaft 75 to compress the fuel mixture inside of the combustion chamber 73, which is referred to as the “compression” phase of the four stroke combustion process. Similar to the actuation of the piston 71 in FIG. 2A, the crankshaft 75 actuates the piston 71 in FIG. 2B using power siphoned from other power strokes of other cylinders 15. The process of actuating the piston 71 in FIG. 2B is completed when the piston 71 reaches the height of its motion, which is referred to as Top Dead Center (TDC) due to the cylinder 15 being at the top of its travel path. At this point, the process transitions to FIG. 2C, which represents the power phase of the four stroke combustion process.

As shown in FIG. 2C, the power phase initiates by igniting the compressed fuel mixture with the spark plug 65. The subsequent rapid expansion of the combusting fuel mixture causes the piston 71 to actuate downward and transfer its motion to the crankshaft 75. The power phase depicted in FIG. 2C is complete when the piston 71 has substantially reached its lowermost point of motion, which is referred to as Bottom Dead Center (BDC) herein.

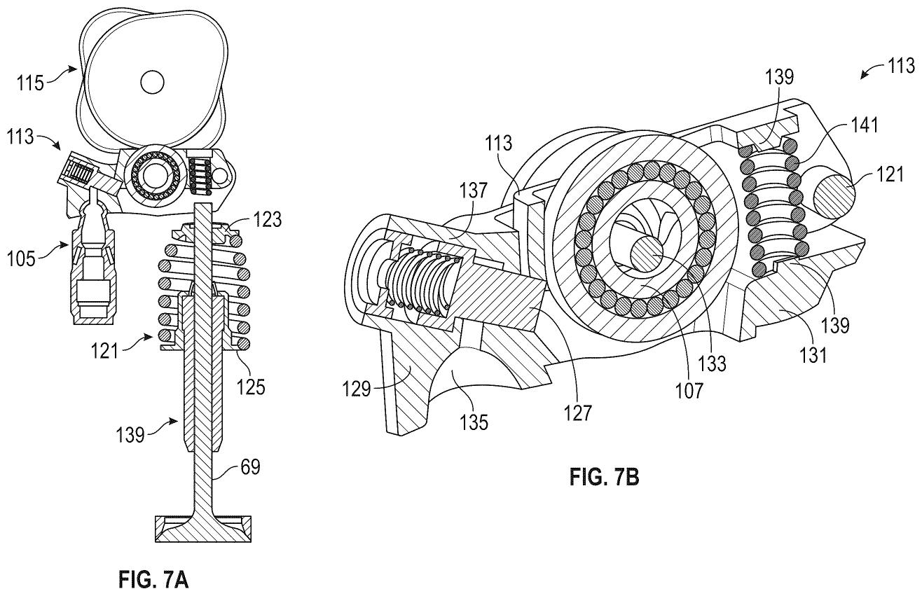

Once the power phase of FIG. 2C is complete the process continues to FIG. 2D, which depicts the exhaust phase of the four stroke combustion process. During the exhaust phase, the exhaust camshaft 41 facilitates the actuation of an exhaust valve 69 by actuating Roller Finger Followers (RFF) (e.g., FIG. 7A), and the actuation of the exhaust valves 69 controls the diameter of the fluid passageway between the cylinder 15 and the exhaust manifold 43 (i.e., the scavenge ports 53 and the blowdown ports 51). The piston 71 is actuated by the crankshaft 75 during this time to actively force exhaust gases from the cylinders 15 by reducing the volume of the combustion chamber 73. Once the exhaust gases have been removed from the cylinder 15, the four stroke combustion process is complete, and restarts with the intake phase depicted in FIG. 2A. This process may be repeated for any number of cycles while the engine 11 is operational.

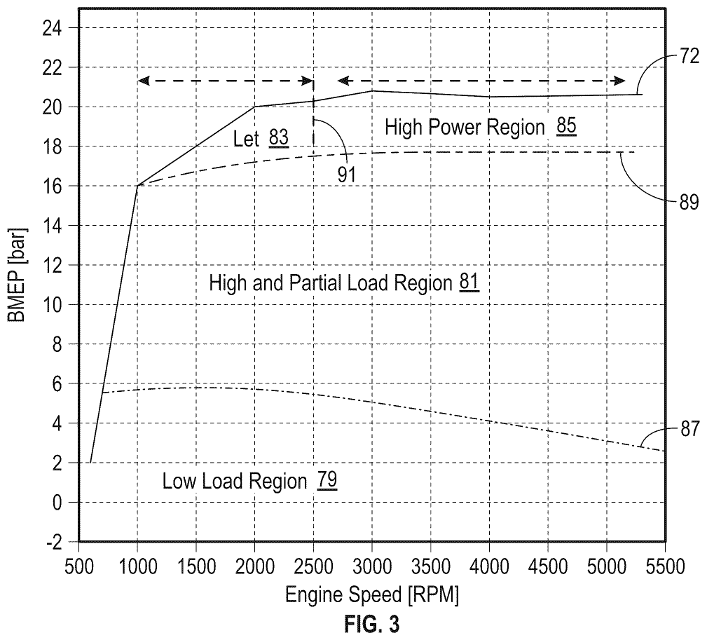

FIG. 3 depicts a graph of a full load curve and operating range for an engine 11. The horizontal axis of FIG. 3 represents engine speed in units of Revolutions Per Minute (RPMs). The vertical axis of FIG. 3 represents Brake Mean Effective Pressure (BMEP) in units of bar. As is known in the art, BMEP represents the average pressure in the combustion chamber during the power stroke (i.e., FIG. 2C), and is a function of an engine's output power and displacement volume. BMEP is a useful metric for comparing engine output performance, as it accounts for the size of the engine and the output power produced by the engine.

In general, FIG. 3 serves to define terms for the remainder of this disclosure. In this regard, FIG. 3 depicts a maximum load line 77 that provides an upper boundary for potential engine operating points. Points occupying the maximum load line 77 thus define specific maximum engine speed and BMEP operating conditions for an engine 11 as described herein. For example, the maximum load line 77 of FIG. 3 depicts that the maximum BMEP achieved by the engine 11 is approximately 21 bar at an engine speed of 3000 RPMs.

The area beneath the maximum load line 77, which represents the possible engine 11 operating points, is separated into four distinct regions by a plurality of predetermined thresholds. A first predetermined BMEP threshold 87 delimits a boundary between a low load region 79 and a high and partial load region 81. A second predetermined BMEP threshold 89 separates the high and partial load region 81 from a Low End Torque (LET) region 83 and a high power region 85. The LET region 83 is separated from the high power region 85 by a predetermined engine speed threshold 91. The low load region 79 generally defines low power output and/or low air flow, and corresponds to operating conditions such as minimal acceleration or low engine speeds. In general, the low load region 79 captures engine operating points with a low BMEP. Depending on the engine speed, the first predetermined BMEP threshold 87 may encompass up to approximately 5.9 bar (e.g., at 1500 RPM), or as little as approximately 2.7 bar (e.g., at 5500 RPM).

The second predetermined BMEP threshold 89 depicts that the maximum BMEP for the high and partial load region 81 is approximately 16 bar at 1000 RPM, and increases to a maximum BMEP of approximately 17.8 bar at 5000 RPM. The high and partial load region 81 thus denotes engine operating points where a moderate amount of power is provided by the engine. For example, the high and partial load region 81 may be utilized in a case where a driver is rapidly accelerating (but not at full throttle), such as when merging onto a highway or interstate.

The LET region 83 and the high power region 85, which are positioned above the second predetermined BMEP threshold 89, generally define high load conditions. The LET region 83 captures BMEP values at engine speeds below the predetermined engine speed threshold 91, which is positioned at 2500 RPM in FIG. 3. The LET region 83 corresponds to real world conditions such as towing or driving in stop-and-go traffic, where high toque is experienced but engine speeds remain minimal. The high power region 85 captures BMEP values above the second predetermined BMEP threshold 89 at engine speeds above the predetermined engine speed threshold 91, and corresponds to real world conditions where the engine achieves high or maximum acceleration (commonly referred to as “wide open throttle”).

Overall, FIG. 3 presents that an engine 11 as described herein may be operated at BMEP value and engine speed combinations that occupy one of four distinct regions: the low load region 79, the high and partial load region 81, the LET region 83, and the high power region 85. As explained further below, the ECU 23 determines a control scheme for the exhaust valves 69 bordering the blowdown ports 51 and the scavenge ports 53 based upon which region corresponds to the current operating parameters of the engine 11.

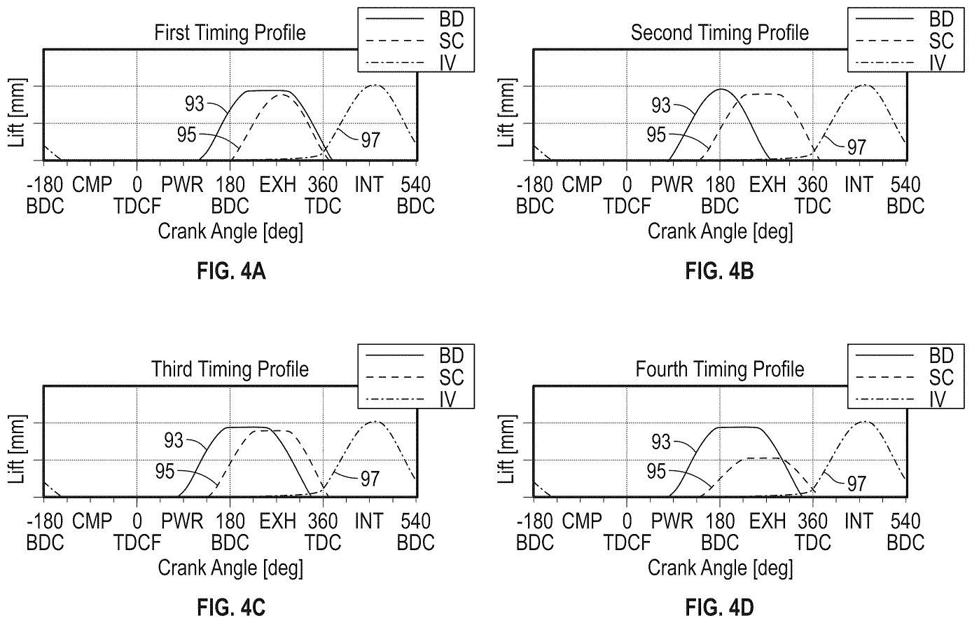

FIGS. 4A-4D describe timing profiles for controlling valve events of the intake valve 67 and the exhaust valves 69, respectively. The timing profiles are utilized by the ECU 23 to determine the time to issue operating instructions to each of the intake valve 67 and the intake valve 67. The valve events of FIGS. 4A-4D are related to the regions of the operating curve depicted in FIG. 3 as discussed further below. The horizontal axis of each of FIGS. 4A-4D denotes a rotation angle of a crankshaft as measured by a crankshaft position sensor (e.g., FIG. 9). Along the horizontal axis, the abbreviations “CMP”, “PWR”, “EXH”, and “INT” represent the compression stroke (e.g., FIG. 2B), the power stroke (e.g., FIG. 2C), the exhaust stroke (e.g., FIG. 2D) and the intake stroke (e.g., FIG. 2A). The abbreviations “BDC” and “TDC” relate to the piston 71 positions of Bottom Dead Center (BDC) and Top Dead Center (TDC) respectively. The abbreviation “TDCF” thus corresponds to the first time a piston 71 reaches TDC. The vertical axis of each of FIGS. 4A-4D denotes the relative valve lift, in millimeters (mm), of the corresponding intake valve 67 or exhaust valve 69.

Three curves are depicted in each of FIGS. 4A-4D. A first curve, blowdown curve 93, represents the valve lift and timing of the actuation of exhaust valves 69 associated with the blowdown ports 51. A second curve, scavenge curve 95, represents the valve lift and timing of the actuation of exhaust valves 69 associated with the scavenge ports 53. A third curve, intake curve 97, denotes the valve lift and timing of the actuation of intake valve 67 associated with the intake port 49.

FIG. 4A specifically illustrates a first timing profile depicting an extended blowdown event with scavenge valve overlap. The extended blowdown event is depicted by the blowdown curve 93 extending from approximately 130 degrees to approximately 375 degrees (i.e., 15 degrees into a second rotation of the crankshaft). On the other hand, the scavenge curve 95 extends from approximately 180 degrees to 370 degrees, and the intake curve 97 extends from approximately 340 degrees to approximately −140 degrees (shown on the left hand side of FIG. 4A). In the context of FIG. 4A, a crank angle of −140 degrees is equivalent to a rotation angle of 540 degrees, as a complete engine cycle occurs over 720 degrees of crankshaft rotation. That is, a crank angle of −140 implies that an event (i.e., intake valve 67 closure) occurs 140 degrees prior to the initiation of a subsequent engine cycle. Overall, FIG. 4A illustrates that the extended blowdown event represented by the blowdown curve 93 encompasses at least 225 degrees of crankshaft rotation. Thus, and as utilized herein, the phrase “extended event” or “extended valve event” refers to a period of time encompassing at least 225 degrees of crankshaft rotation. Such is in juxtaposition to a “typical event” or a “standard event”, which refers to a period of time encompassing approximately 160-200 degrees of crankshaft rotation.

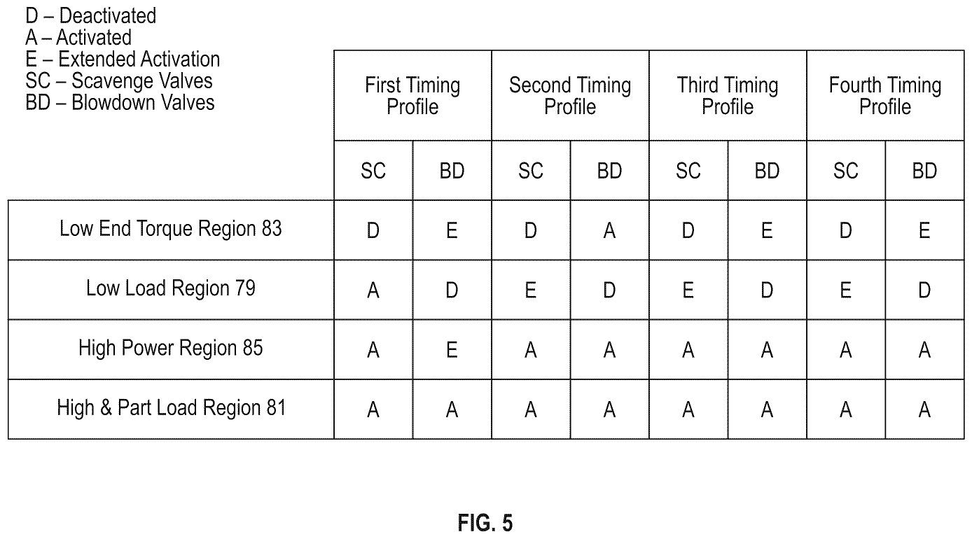

As noted above, the valve events depicted in FIGS. 4A-4D correspond to the various regions of the operating curve depicted in FIG. 3. FIG. 4A specifically corresponds to situations where the engine 11 is operated in the high power region 85, where the BMEP is greater than approximately 17.8 bar and the engine speed is greater than 2500 RPMs for the specific configuration described herein. From FIG. 4A, it can be seen that the blowdown curve 93 completely encompasses the scavenge curve 95, which is the “valve overlap” concept discussed above. In a real world sense, this implies that the exhaust valves 69 associated with the blowdown ports 51 is actuated over a longer lift distance and is open for a longer period of time than the exhaust valves 69 associated with the scavenge ports 53. The intake curve 97 substantially occurs after the blowdown and scavenge events, and there is minor lift overlap to prevent a vacuum environment in the combustion chamber 73. Benefits of the extended valve event depicted in FIG. 4A are further discussed below in relation to FIG. 5.

FIG. 4B depicts a second timing profile with a standard blowdown event and an extended scavenge event. The standard blowdown event is reflected by the blowdown curve 93 extending 180 degrees, from approximately 90 degrees to approximately 270 degrees. The extended scavenge event is reflected by the scavenge curve 95 extending from approximately 145 degrees to approximately 370 degrees. It is noted that the second timing profile appears to depict both a blowdown event and a scavenge event that overlap. Such is not the case because, and as will be explained further in relation to FIG. 5, the exhaust valves 69 associated with the blowdown ports 51 are deactivated while the exhaust valves 69 associated with the scavenge ports 53 are actuated for an extended duration. Rather, the blowdown curve 93 depicts a typical blowdown event that may occur while operating the engine 11 in the high power region 85, the LET region 83, and the high and partial load region 81. On the other hand, the extended scavenge event occurs while operating the engine 11 in the low load region 79, when the exhaust valves 69 associated with the blowdown ports 51 are deactivated. Thus, FIG. 4B is correctly interpreted as depicting a blowdown event that may occur while operating the engine 11 in the high power region 85, the LET region 83, and the high and partial load region 81, whereas the extended scavenge event occurs in a separate region (i.e., the low load region 79). While operating the engine 11 in other regions of FIG. 3, the scavenge event may have a typical duration.

FIG. 4C depicts a third timing profile having an extended blowdown event and an extended scavenge event. The extended blowdown event is depicted by the blowdown curve 93 extending from approximately 90 degrees to approximately 330 degrees. The extended scavenge event is depicted by the scavenge curve 95 extending from approximately 130 degrees to approximately 380 degrees. The blowdown event includes a larger valve lift that the scavenge event, which implies that the volumetric flow rate of exhaust gases is greater during the blowdown event than the scavenge event. The intake event as depicted by the intake curve 97 extends from approximately 340 degrees to approximately −140 degrees. Thus, the scavenge event overlaps with the intake event from 340 degrees to 380 degrees. The extended blowdown event of FIG. 4C occurs while operating the engine 11 in the LET region 83, whereas the extended scavenge event occurs while operating the engine 11 in the low load region 79.

FIG. 4D depicts an extended blowdown event and an extended scavenge event with a large disparity in valve lift. Similar to FIG. 4C, the extended blowdown event occurs while operating the engine 11 in the LET region 83, whereas the extended scavenge event occurs while operating the engine 11 in the low load region 79. The large disparity in valve lifts is depicted by the maximum height of the blowdown curve 93 being approximately 1.7 times greater than the maximum height of the scavenge curve 95. The valve lift disparity allows a reduced scavenge volumetric flow rate, which improves LET performance of the engine 11. The large disparity and lengthy blowdown event diverts a bulk of the exhaust gases to the turbine 37, allowing for the turbine 37 to be sized with larger vanes than a conventional turbine. In turn, the larger turbine 37 vanes have a higher efficiency than smaller vanes due to differences in the surface to volume ratio therebetween. Thus, the extended blowdown event with valve lift disparity as depicted in FIG. 4D provides better turbine 37 efficiency overall by allowing the engine 11 to be paired with a larger turbine 37 than typically afforded by conventional sizing constraints.

Overall, each timing profile depicted in FIGS. 4A-4D is rooted in maintaining Piston-Valve Contact Limit (PVCL) compliance. In general, PVCL relates to the minimum clearance between a piston 71 and the associated valves 67, 69. The clearance between the piston 71 and the valves 67, 69 is a function of various engine design parameters such as, but not limited to, piston 71 diameter, valve 67, 69 and valve seat (not shown) geometry, and engine operating pressure. In the event that contact is anticipated between the piston 71 and either valve 67, 69 (for example, anticipated by a system engineer during engine design or determined by the ECU during engine operation), the valve event (e.g., opening or closing a valve 67, 69) may be advanced or delayed in order to maintain PVCL compliance.

Turning to FIG. 5, FIG. 5 is a chart that provides an overview of the duration of the various valve events discussed in FIGS. 4A-4D as they relate to the regions of the operating curve depicted in FIG. 3. The columns of FIG. 5 correspond to the exhaust valves 69 and one of the timing profiles illustrated in FIGS. 4A-4D. The rows of FIG. 5 correspond to the regions of the engine 11 operating curve depicted in FIG. 3. Individual cells of FIG. 5 thus denote the duration of a valve event for a corresponding exhaust valve 69 at a particular engine 11 operating load. The cells of FIG. 5 are given one of three abbreviations denoting the duration of the associated valve event. The abbreviation “D” corresponds to a deactivated state or closed exhaust valve 69. The abbreviation “A” denotes that the corresponding exhaust valve 69 is opened or in an activated state for at least part of the engine cycle. The abbreviation “E” denotes an extended valve event encompassing at least 225 degrees of crankshaft rotation, or 225 Crank Angle Degrees (CAD). The abbreviation “SC” denotes columns associated with exhaust valves 69 positioned adjacent to the scavenge ports 53, whereas the abbreviation “BD” denotes columns associated with exhaust valves 69 positioned adjacent to blowdown ports 51.

For the sake of compact discussion, exhaust valves 69 associated with the scavenge ports 53 are described as “scavenge valves”. In the same vein, exhaust valves 69 associated with blowdown ports 51 are referred to as “blowdown valves”. Opening and closing an exhaust valve 69 associated with a scavenge port 53 is denoted as a “scavenge event”. Similarly, opening and closing an exhaust valve 69 associated with a blowdown port 51 is denoted as a “blowdown event”.

The first column of FIG. 5, which is associated with the first timing profile of FIG. 4A, depicts that scavenge valves are deactivated in the LET region 83, and are active for all other operating regions. On the other hand, the second column of FIG. 5, which still corresponds to FIG. 4A, depicts that the blowdown valves are activated in the high and partial load region 81. The blowdown event is extended in the LET region 83 and the high power region 85, and the blowdown valves are deactivated while operating the engine 11 in the low load region 79.

As a result of the above, an engine 11 operating according to the first timing profile diverts all exhaust gases to the turbine 37 while the engine 11 operates in the LET region 83. In turn, the increased exhaust gas flow rate through the turbine 37 produces more boost in the compressor 33, which generates additional torque. While the engine 11 operates in the low load region 79, the scavenge valves are activated and the blowdown valves are deactivated, diverting all exhaust gases to the catalytic conversion device 57. The activation of the scavenge valves allows for hot exhaust gases to be directed towards the catalytic conversion device 57, maximizing the catalytic conversion rate thereof. In addition, the scavenge event may be advanced (i.e., the scavenge curve 95 is shifted to the left) to further increase the temperature of the exhaust gases routed to the catalytic conversion device 57.

Still continuing with the first timing profile of FIG. 5, while the engine 11 operates in the high power region 85 the scavenge valves are activated and the blowdown event is extended. This diverts a bulk, but not all, of the exhaust gases to the turbine 37 over the catalytic conversion device 57. While operating in the high power region 85, excessive exhaust gas pressure in the blowdown line 45 may be relieved during the extended valve event using a waste gate (not shown) of the turbocharger, or by controlling the geometry of the vanes of the turbine 37 in order to allow some of the exhaust gases to bypass the turbine 37. In the high and partial load region 81, the scavenge valves and the blowdown valves are activated for a substantially similar length of time. While operating in the high and partial load region 81 intake throttling may be applied (i.e., reducing the aperture of a throttle) to compensate for the excessive work generated by the turbine 37.

The second timing profile depicted in FIG. 4B corresponds to columns three and four of FIG. 5. In this regard, columns three and four depict that the scavenge valves and are deactivated and the blowdown valves are activated while operating the engine 11 in the LET region 83. As a result of the deactivation of the scavenge valves, all exhaust gases are diverted towards the turbine 37. In order to ensure proper torque delivery in the LET region 83 with closed scavenge valves, the blowdown event of FIG. 4B may be advanced. Alternatively, or additionally, the ECU 23 may advance the spark timing of the spark plugs (e.g., FIG. 9) to increase peak pressure in the cylinders 15 while operating the engine 11 in the LET region 83 per the second timing profile.

Still continuing with the columns three and four of FIG. 5, at low load conditions corresponding to the low load region 79 the second timing profile includes an extended scavenge event and deactivated blowdown valves. As discussed above, the extended scavenge event allows for additional hot exhaust gases to be directed to the catalytic conversion device 57, allowing for more efficient conversion of the hot exhaust gases. Further catalytic conversion benefits may be experienced by advancing the timing of the scavenge event (i.e., shifting the scavenge curve 95 of FIG. 4B leftwards). At high power conditions and high and partial load conditions, the blowdown valves and the scavenge valves are activated for a typical duration (i.e., approximately 180 degrees). The usage of both the blowdown valves and the scavenge valves aids in preventing excessive pumping losses in the turbine 37. If necessary, pumping losses may be further reduced by adjusting the aperture of the waste gate (not shown) or adjusting the vanes of the turbine 37 to allow exhaust gases to bypass the turbine 37.

Columns five and six of FIG. 5 relate to blowdown and scavenge events for the third timing profile as depicted in FIG. 4C. While operating the engine 11 in the LET region 83, the ECU 23 deactivates the scavenge valves and extends the blowdown event. This causes all exhaust gases to be routed to the turbine 37, increasing the amount of compressed air output by the compressor 33 and increasing in-cylinder pressure. The increased cylinder 15 pressure aids in providing adequate torque delivery to a driver by increasing the torque output of the engine 11. While operating the engine 11 in the low load region 79, the configuration is reversed such that the scavenge event is extended and the blowdown valves are deactivated. As discussed above, closing the blowdown valves and extending the scavenge event routes all exhaust gases to the catalytic conversion device 57, which aids in warming the catalyst thereof. Similar to the second timing profile, the third timing profile includes activating the scavenge valves and the blowdown valves while operating the engine 11 in the high power region 85 or the high and partial load region 81.

Columns seven and eight of FIG. 5 relate to blowdown and scavenge events for the fourth timing profile as depicted in FIG. 4D. The valve events of the fourth timing profile are substantially similar in duration to the valve events of the third timing profile, such that columns seven and eight are substantial duplicates of columns five and six. However, and as discussed in relation to FIGS. 4C and 4D, the third timing profile involves a similar valve lift for the blowdown valves and the scavenge valves, whereas FIG. 4D has a large valve lift displacement disparity between the blowdown and scavenge valves. Thus, the flow rate of exhaust gases through the blowdown valves is substantially greater than the flow rate of exhaust gases through the scavenge valves according to the fourth timing profile, whereas the third timing profile assumes a similar flow rate across the blowdown valves and the scavenge valves. An engine 11 configured to operate according to the fourth timing profile may thus be sized with a larger turbine 37 than an engine 11 configured to operate according to the third timing profile in order to compensate for the increased amount of exhaust gases flowing to the turbine 37.

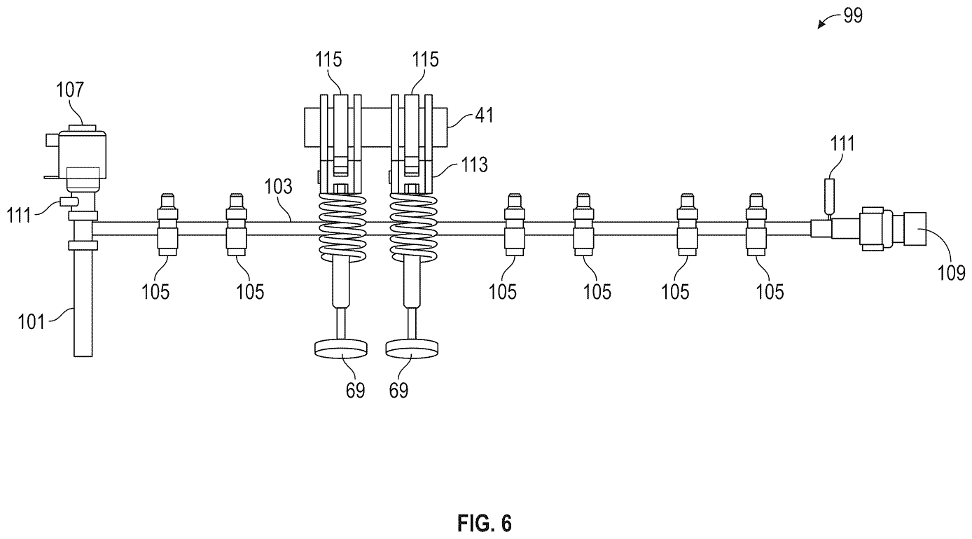

Turning to FIGS. 6-8B, these Figures are directed towards various hardware components that facilitate exhaust valve 69 actuation. In particular, FIG. 6 presents an overview of a valvetrain actuation system 99 utilized to facilitate the activation and deactivation of the exhaust valves 69. On the other hand, FIGS. 7A-8B depict detailed examples and alternate views of components depicted in the valvetrain actuation system 99 of FIG. 6.

As shown in FIG. 6, the valvetrain actuation system 99 includes a first oil line 101, which carries oil from a Main Oil Gallery (MOG) of the engine 11. The engine 11 includes a lubrication system which may include, for example, an oil pan (not shown), an oil pump (not shown), an oil circuit (not shown), a gallery oil pump (e.g., FIG. 9), and the MOG (not shown), which distributes oil to the main bearings of engine 11. Thus, the first oil line 101 serves to divert a portion of oil from the MOG to the valvetrain actuation system 99. The first oil line 101 is fluidly connected to a second oil line 103 that feeds oil to a plurality of lash adjusters 105, discussed further below. The pressure of the oil disposed in the second oil line 103 is controlled by way of an oil control valve 107, which is a solenoid driven valve that regulates the flow of oil into the second oil line 103, and thus the valvetrain actuation system 99 as a whole.

Measurements of the oil pressure within the second oil line 103 are captured by the lash oil pressure sensor 109 depicted in FIG. 6, which is disposed at an opposite end of the second oil line 103 from the oil control valve 107. Thus, the lash oil pressure sensor 109 may be formed, for example, as a diaphragm attached to a variable resistance resistor, such that the diaphragm is actuated to create a measurable resistance that corresponds to the oil pressure within the second oil line 103. The oil control valve 107 and the lash oil pressure sensor 109 each include a vent 111 that allows air trapped in the first oil line 101 and the second oil line 103 to be vented to the external environment of the engine 11.

The oil disposed in the second oil line 103 is dispersed to a plurality of lash adjusters 105. The lash adjusters 105 are disposed in pairs, such that each cylinder 15 corresponds to a pair of lash adjusters 105. Functionally, the lash adjusters 105 are embodied as fluid outlets that serve to deliver oil from the second oil line 103 to a corresponding tri-roller Roller Finger Follower (RFF) 113 in order to facilitate valve event transitions. The lash adjusters 105 also provide a pivot point for the RFF 113 to rotate about when actuated by the exhaust camshaft 41. The tri-roller RFF 113 is actuated by a corresponding cam 115, and the structure of the tri-roller RFF 113 is further discussed below in relation to FIG. 7A. Each cam 115 includes an inner lobe (e.g., FIG. 8B) and two outer lobes (e.g., FIG. 8B), the purpose of which is discussed further below. The cams 115 are fixed to the exhaust camshaft 41, such that the actuation of the exhaust camshaft 41 is transferred to the corresponding cam 115.

The tri-roller RFF 113 actuates exhaust valves 69 of the engine 11. In this regard, the tri-roller RFF 113 is positioned to simultaneously abut against a corresponding cam 115 and a corresponding exhaust valve 69. Thus, as further discussed below, in addition to controlling which lobe (e.g., FIG. 8B) of a corresponding cam 115 is currently facilitating the engine 11 operation, the tri-roller RFF 113 serves to mechanically couple the motion of the selected lobe to the corresponding exhaust valve 69.

Turning to FIG. 7A, FIG. 7A depicts a side view of some of the components forming the valvetrain actuation system 99 discussed in FIG. 6. Specifically, FIG. 7A depicts a cam 115, a tri-roller RFF 113, a lash adjuster 105, an exhaust valve 69, a valve spring 121, a spring cap 123, and a spring seat 125. As discussed above, the lash adjuster 105 is a tube or conduit that forms a fluid outlet from the second oil line 103 to a particular tri-roller RFF 113. Depending on the oil pressure delivered by the lash adjuster 105, the tri-roller RFF 113 occupies one of two positions. In a first position, a lock pin (e.g., FIG. 7B) is engaged and the tri-roller RFF 113 contacts an inner lobe (e.g., FIG. 8B) of the cam 115, while also contacting the outer lobes (e.g., FIG. 8B) thereof. In the second position, the lock pin (e.g., FIG. 7B) is retracted and the tri-roller RFF 113 contacts the outer lobes (e.g., FIG. 8B) of the cam 115. The inner cam lobe (e.g., FIG. 8B) contacts a central bearing (e.g., FIG. 7B), which deflects against the spring 141 and does not cause valve motion. This is called “lost motion,” as the motion of the inner cam lobe (e.g., FIG. 8B) does not cause response from the engine 11.

As noted above, the cam 115 actuates a corresponding exhaust valve 69 according to its cam profile, such that the linear displacement of the corresponding exhaust valve 69 is controlled by the position of the cam lobes (e.g., FIG. 8B). Thus, by using the tri-roller RFF 113 to switch between cam lobes, the engine 11 as a whole is capable of activating and deactivating each exhaust valve 69 according to an associated timing profile. Furthermore, because the actuation of the tri-roller RFF 113 is tied to the fluid delivery provided by the lash adjuster 105, the motion of the tri-roller RFF 113 is controlled by regulating the oil pressure within the lash adjuster 105. Moreover, because the exhaust valve 69 displacement is a function of the selected cam lobe, the displacement of the corresponding exhaust valve 69 is also a function of the oil pressure within the lash adjuster 105, or more generally as a function of the oil pressure of the second oil line 103. A valve spring 121 abuts against a spring cap 123 attached to the tri-roller RFF 113 and a spring seat 125 attached to the exhaust valve 69. The valve spring 121 provides a force on the exhaust valve 69 to ensure contact between the tip of the exhaust valve 69, the tri-roller RFF 113, and cam 115 surfaces while operating the engine 11.

FIG. 7B depicts a tri-roller RFF 113 in accordance with one or more embodiments of the invention described herein. As shown in FIG. 7B, the tri-roller RFF 113 includes a body 129 and an arm 131, which are solid in nature and may be formed of iron or steel, for example. The body 129 and the arm 131 are mechanically coupled by way of a shaft 133 such that the body 129 may rotate relative to the arm 131 and vice versa.

The lash adjuster 105 is embodied as a tube or conduit, and extends into the underside of the body 129 to deliver oil into a socket 135 of the body 129. The body 129 includes a cavity 137 that contains a lock pin 127 that is actuated by oil received from the socket 135 (which receives oil from the lash adjuster 105) to withdraw from a first position to a second position. In the first position, the lock pin 127 abuts against an arm 131. The arm 131 is fixed to or integrally formed with the inner bearing trace of the bearing 143, and is further connected by a shaft 133 to the body 129. Thus, the lock pin 127 prevents the arm 131 from rotating in a counterclockwise motion when the lock pin 127 is in the first position. In the second position, the lock pin 127 is at least partially withdrawn into the cavity 137 such that the lock pin 127 does not contact the arm 131, and the arm 131 may rotate in a counterclockwise direction relative to the body 129.

Each of the arm 131 and the body 129 include a spring guide 139, which is an integrally formed beveled protrusion that serves to retain a spring 141. In particular, the spring 141 depicted in FIG. 7B is compressed between a spring guide 139 of the body 129 and a spring guide 139 of the arm 131. The spring 141 applies a compressive force to the body 129 and the arm 131 that causes the bearing 143 to continuously abut against the inner lobe (e.g., FIG. 8B).

The first and second positions of the lock pin 127 further correspond to whether an exhaust valve 69 is activated or deactivated. While the lock pin 127 is in the first position (i.e., abutted against the arm 131), the arm 131 forces the bearing 143 to remain in an upper position. While the bearing 143 is in this first position, the bearing 143 contacts an inner lobe (e.g., FIG. 8B) of the cam 115 such that the body 129 actuates the exhaust valve 69 according to the profile of the inner lobe (i.e., the exhaust valve 69 is activated).

On the other hand, while the lock pin 127 is in the second position (i.e., at least partially withdrawn into the cavity 137), the inner lobe (e.g., FIG. 8B) of the cam 115 causes rotational movement of the arm 131 and forces the bearing 143 (and roller elements connected thereto) downward into a lower position. As a result of the bearing 143 being in the lower position, the inner lobe (e.g., FIG. 8B) of the cam 115 does not actuate the exhaust valve 69. Rather, outer lobes (e.g., FIG. 8B) of the cam 115 contact outer rollers (e.g., FIG. 8A) of the body 129, and this causes the body 129 to actuate according to the profile of the outer lobes (e.g., FIG. 8B) of the cam 115. The motion of the outer rollers is lost, and does not cause the exhaust valve 69 to actuate. Thus, depending upon the position of the lock pin 127 as a function of the oil pressure in the socket 135, each exhaust valve 69 can be activated or deactivated. The determination of whether a particular exhaust valve 69 is to be activated or deactivated is discussed above in relation to FIG. 5. Thus, FIGS. 7A and 7B depict one example of hardware that may be used to activate or deactivate a particular exhaust valve 69 associated with a blowdown port 51 or a scavenge port 53.

Turning to FIG. 8A, FIG. 8A depicts an isometric view of the exterior of the tri-roller RFF 113. As shown in FIG. 8A, outer rollers 145 are fixed to the exterior of the body 129. The outer rollers 145 may be formed, for example, as encased bearings with a central shaft or bearing trace that is integrally formed with or otherwise rigidly fixed to the body 129. As noted above, the outer rollers 145 function to receive motion from the cam 115 when an exhaust valve 69 is deactivated, and said motion is lost and does not cause actuation of another engine 11 component.

FIG. 8B depicts an isometric cutaway view of various components discussed previously in relation to FIGS. 7A and 7B, with a particular emphasis on the structure of the cam 115. As discussed previously, a tri-roller RFF 113 is actuated by oil supplied from a lash adjuster 105 to abut against the cam 115, and the tri-roller RFF 113 further actuates an exhaust valve 69 according to the active lobe of the cam 115. In this case, the term “active” refers to a lobe of the cam 115 that is currently abutted against the tri-roller RFF 113, whereas the other lobe(s) are considered to be “inactive” insofar as the other lobe(s) are freely rotating without actuating the tri-roller RFF 113.

The cam 115 is formed with two separate cam profiles that respectively correspond to the shape of an inner lobe 147 and an outer lobe 149. As shown in FIG. 8B, the inner lobe 147 is positioned immediately above a bearing 143 forming the center roller of the tri-roller RFF 113, whereas the outer lobes 149 are positioned immediately above outer rollers 145 of the tri-roller RFF 113. As a consequence of this arrangement, the inner lobe 147, which contacts the bearing 143, also corresponds to an activated exhaust valve 69 such that the exhaust valve 69 is actuated according to the profile of the inner lobe 147. The outer lobe 149 is shaped with a profile corresponding to a deactivated exhaust valve 69, and the tri-roller RFF 113 follows the outer lobe 149 while the associated exhaust valve 69 is deactivated. Depending on whether the outer lobe 149 or the inner lobe 147 is in contact with the tri-roller RFF 113, each exhaust valve 69 may be activated (including extended activation) or deactivated.

Turning now to FIG. 9, FIG. 9 depicts a block diagram of various hardware components connected to the Electronic Control Unit (ECU) 23. As discussed above, the ECU 23 operates to control whether one or both of the scavenge valves and the blowdown valves are activated. Thus, FIG. 9 depicts hardware components that feed information or receive instructions from the ECU 23 in order to enable exhaust valve 69 activation and deactivation. In this regard, components depicted in FIG. 9 as being connected to the left hand side of the ECU 23 represent sensors that feed information to the ECU 23. On the other hand, components connected to the right hand side of the ECU 23 represent actuatable components that are controlled by the ECU 23 to physically facilitate exhaust valve 69 actuation. The various components of FIG. 9 are interconnected by way of a wiring harness 61, which is a bundle of wires that form electrical pathways between the ECU 23 and the various sensors and actuatable components discussed above.

For its part, the ECU 23 includes a memory 153 and a processor 155. The processor 155 is formed by one or more processors, integrated circuits, microprocessors, or equivalent computing structures that serve to execute computer readable instructions stored on the memory 153. Thus, the memory 153 includes a non-transitory storage medium such as flash memory, a Hard Disk Drive (HDD), a solid state drive (SSD), a combination thereof, or equivalent storage devices. In relation to the invention as described herein, the memory 153 stores computer readable instructions, executed by the processor 155, that relate to controlling the engine 11 to operate according to the timing profiles discussed in relation to FIGS. 4A-4D.

As shown in FIG. 9, the sensors include a lash oil pressure sensor 109, a gallery oil pressure sensor 157, a camshaft position sensor 159, a crankshaft position sensor 161, a boost pressure sensor 163, a fuel rail pressure sensor 165, a cylinder pressure sensor 167, and a pedal 59.

The functions of the lash oil pressure sensor 109 have been discussed previously above. Briefly, the lash oil pressure sensor 109 is disposed on one end of the second oil line 103, and serves to measure the interior oil pressure thereof. The oil pressure in the second oil line 103 is used to actuate the tri-roller RFFs 113. Additionally, the oil pressure in the second oil line 103 is regulated by the oil control valve 107 based upon instructions received from the ECU 23.

The functions of the pedal 59 have also been discussed above. Briefly, the pedal 59 serves to capture a request for additional torque from a driver of a vehicle comprising the engine 11. The pedal 59 may be practically embodied as a lever attached to a potentiometer, where the potentiometer transmits resistance readings to the ECU 23 that correlate to the actuation of the lever.

The gallery oil pressure sensor 157 serves to measure the pressure of oil in the Main Oil Gallery (MOG). To this end, the gallery oil pressure sensor 157 may be embodied as a diaphragmatic pressure sensor that transmits a resistance that corresponds to the pressure of oil in the MOG. As noted above, the lubrication system (not shown) of the engine 11 includes an oil pan (not shown), an oil distribution circuit (not shown) that extends throughout the engine 11, and a MOG that supplies oil to the main bearings (not shown) of the engine 11. The gallery oil pressure sensor 157 is positioned on the MOG to measure the overall oil pressure of the MOG. A gallery oil pump 171 functions to pressurize the oil in the MOG, and is controlled by the ECU 23 to facilitate proper lubrication of components of the engine 11.

The camshaft position sensors 159 are embodied as rotary encoders. The camshaft position sensors 159 are fixed to each of the intake camshaft 39 and the exhaust camshaft 41 such that each camshaft includes a corresponding camshaft position sensor 159. Thus, the camshaft position sensors 159 serve to capture the positions of the various camshafts 39 and 41, and each camshaft position sensor 159 transmits the current rotation angle of its associated camshaft to the ECU 23. Similarly, the crankshaft position sensor 161 is embodied as a rotary encoder that captures the current rotation angle and rotation speed of the crankshaft 75. As discussed above, the positions of the intake camshaft 39, the exhaust camshaft 41, and the crankshaft 75 are utilized by the ECU 23 to coordinate the timing of various operations of the combustion process. For example, based upon the position of the crankshaft 75 and the associated signal received from the camshaft position sensors 159, the ECU 23 determines the timing for operating the fuel injectors 63. As a second example and as discussed above, the ECU 23 determines whether the exhaust valves 69 should be activated or deactivated based in part upon the rotation speed of the crankshaft 75, and actuates the oil control valve 107 according to the determination. Although the considerations for the ECU 23 have been described thus far as relating to the engine 11 rotation speed and BMEP, the ECU 23 may determine whether to activate a particular exhaust valves 69 based upon additional input such as, but not limited to, a desired emissions level or content, a desired fuel economy, a desired thermal or mechanical efficiency, or other performance metrics discussed further below and appreciated by a person skilled in the art.

To measure the boost pressure created by the compressor 33, the engine 11 includes a boost pressure sensor 163. The boost pressure sensor 163 is embodied as a diaphragm pressure sensor. In addition, the boost pressure sensor 163 is positioned downstream of the compressor 33, such that the boost pressure sensor 163 captures the absolute air pressure prior to the intake manifold 17. On the other hand, boost pressure is controlled, in part, via wastegate 169 control or by varying the angle of adjustable vanes of the turbine 37. As is commonly known in the art, a wastegate 169 is a bypass valve and associated passageway included in the turbocharger that allows exhaust gases to bypass the turbine 37. Thus, the ECU 23 may control the aperture of the bypass valve of the wastegate 169 in order to reduce or increase pressure in the turbine 37, causing a corresponding increase or reduction in intake air compression.

Similar to the boost pressure sensor 163, the engine 11 includes a fuel rail pressure sensor 165 that measures the pressure of fuel in the fuel rail 19. The fuel rail pressure sensor 165 is also embodied as a diaphragm pressure sensor that measures the fluid pressure of the fuel prior to the fuel entering a fuel injector 63.

The cylinder pressure sensor 167 measures the pressure of an associated cylinder 15. The cylinder pressure sensor 167 may include, for example, a piezoelectric pressure sensor as a standalone unit, or a pressure sensor disposed in and integrated with the spark plug 65. The cylinder pressure sensor 167 provides a current cylinder 15 pressure to the ECU 23. The ECU 23 utilizes the current cylinder pressure and engine torque (measured on a dynamometer) to determine the current BMEP for the engine. Thus, by utilizing the sensor 167, the ECU 23 is capable of determining which region of the operating curve of FIG. 5 the engine 11 is currently operating in. Because the exhaust valves 69 are controlled based on the region of the operating curve the engine 11 is operating in, control of the exhaust valves 69 is tied to in cylinder pressure readings taken by the sensor 167.

Overall, based upon readings taken from the above described sensors and/or input from the pedal 59, the ECU 23 controls the operation of the high-pressure fuel pump 21, the turbine 37, the wastegate 169, the fuel injector 63, the oil control valve 107, and the gallery oil pump 171 in a cohesive manner. Collectively, the cohesive operation of the high-pressure fuel pump 21, the turbine 37, the wastegate 169, and the fuel injectors 63 by the ECU 23 facilitates proper combustion of fuel in the cylinders to provide adequate torque deliver to a driver of a vehicle including the engine 11. On the other hand, the cohesive operation of the oil control valve 107 and the gallery oil pump 171 according to measurements taken by the above discussed sensors serves to facilitate valve event transitions, as well as to adequately lubricate various components of the engine 11.

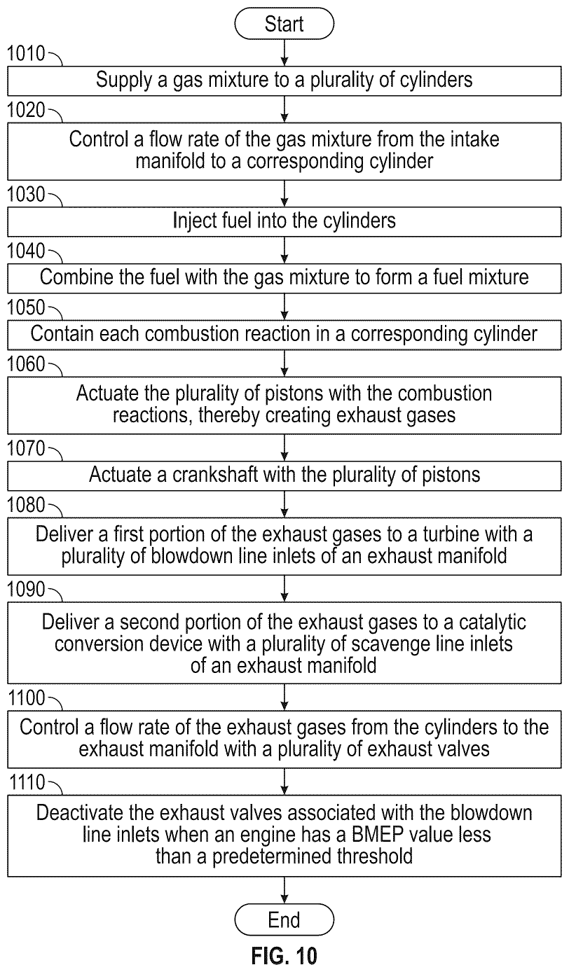

Turning to FIG. 10, FIG. 10 depicts a method for operating an engine 11 in accordance with one or more embodiments of the invention disclosed herein. Steps of FIG. 10 may be performed, for example, using the aforementioned engine 11, but are not limited thereto. The constituent steps of the method depicted in FIG. 10 may be performed in any logical order, and are not limited to the sequence presented. Furthermore, the steps of FIG. 10 may encompass multiple additional actions not depicted that are routine in the art. Moreover, multiple steps of FIG. 10 may be performed as part of a single action, or a single step may comprise multiple actions. Specific steps or portions of steps of FIG. 10 may be described as being performed in relation to a single cylinder, and it is to be understood that such steps are applicable to all cylinders and associated components and are merely described in the context of a single cylinder for the purpose of describing in-cylinder or cylinder specific processes.

The method of FIG. 10 initiates with step 1010, which includes supplying a gas mixture to a plurality of cylinders. The gas mixture is substantially formed by compressed air from the compressor 33. In other embodiments where the engine 11 includes an Exhaust Gas Recirculation (EGR) loop, for example, the gas mixture may further include exhaust gases. Furthermore, if the engine 11 includes a Port Fuel Injector (PFI) instead of Direct Injectors (DI) as described herein, the gas mixture may further include gasoline fuel. The gas mixture is supplied to the cylinders 15 by way of an intake manifold 17 of the engine 11.

Step 1020 includes controlling a flow rate of the gas mixture from the intake manifold 17 to the cylinders 15. The passage between the intake manifold 17 and each cylinder 15 is formed by intake ports 49. The diameter of a specific intake port 49 is controlled by way of a corresponding intake valve 67. Thus, by controlling the aperture and actuation of the intake valve 67, the ECU 23 controls the flow rate, or passage, of the gas mixture to the cylinders 15. Step 1020 is performed in tandem with step 1010, such that the intake valves 67 are actuated while the gas mixture is passed from the intake manifold 17 to the cylinders 15. With the gas mixture present in the cylinders 15, the method continues to step 1030.

In step 1030, fuel is injected into the cylinders 15 with fuel injectors 63. Each cylinder 15 is associated with a corresponding fuel injector 63, and further houses a corresponding piston 71. The ECU 23 determines the injection timing for each fuel injector 63 based, in part, on the position of the crankshaft 75 and the current stroke of the combustion process for the associated cylinder 15. Step 1040 includes combining the fuel injected in step 1030 with the gas mixture supplied in steps 1010 and 1020 to form a fuel mixture. If fuel was supplied via a PFI in step 1010 per an alternative embodiment, then steps 1030 and 1040 may instead be directed towards injecting fuel into the intake manifold 17 and mixing the compressed air and fuel in the intake manifold 17 and cylinders 15. The fuel mixture is subsequently combusted in a combustion reaction initiated by creating a spark with a spark plug 65, which expands the piston 71 and generates work.

Step 1050 includes containing the combustion reaction created in step 1040. In this step, the sidewalls of the cylinders 15 and the cylinder head (not shown) form a containment boundary. As discussed above, the cylinders 15 contain the pistons 71. Thus, as the combustion reaction expands in the cylinder, the sidewalls and cylinder head of the cylinder 15 force the combustion reaction to actuate the piston 71. Step 1050 occurs simultaneous to step 1040, insofar as the process of containing the combustion necessarily occurs while the combustion reaction of step 1040 actuates the piston 71. In step 1060, the combustion reactions in each cylinder actuate the pistons 71. During this step, the pistons 71 are linearly actuated by the combustion reactions, and each piston 71 actuates within a corresponding cylinder 15.

Step 1070 includes actuating a crankshaft 75 with the pistons 71. The crankshaft 75 forms a rotating power output shaft of the engine 11, and power from the crankshaft 75 is transferred to wheels (not shown) to drive a vehicle including the engine 11. Steps 1060 and 1070 occur during the combustion reaction discussed above in relation to step 1040. That is, the combustion reaction is generated in step 1040, and the expansion of the combustion reaction causes the motion of the pistons 71 in step 1060 and the motion of the crankshaft 75 in step 1070.

In step 1080, a first portion of exhaust gases are delivered to a turbine 37. The exhaust gases are created by the combustion reaction of step 1040. The first portion of the exhaust gases is delivered to the turbine 37 by way of a blowdown line 45. Similarly, in step 1090, a second (remaining) portion of the exhaust gases is delivered to a catalytic conversion device 57 by a scavenge line 47. Steps 1080 and 1090 may overlap or the order of these steps may be switched depending on which timing profile the engine 11 is configured to operate according to. The blowdown line 45 and the scavenge line 47 are configured as separate branches of an exhaust manifold 43, and such a configuration is commonly referred to as a Divided Exhaust Boost (DEB) manifold. The blowdown line 45 has inlets fluidly connected to blowdown ports 51 of the engine 11, and the scavenge line 47 has inlets fluidly connected to scavenge ports 53.

Step 1100 includes controlling the flow rate of exhaust gases to the exhaust manifold 43 with exhaust valves 69. The exhaust valves 69 of the engine include scavenge valves positioned adjacent to the inlets of the scavenge line 47 and blowdown valves positioned adjacent to the inlets of the blowdown line 45. The aperture of each exhaust valve 69 is controlled by the ECU 23 according to one of the four timing profiles discussed in relation to FIGS. 4A-5. Similar to step 1020 occurring simultaneous to step 1010, step 1100 occurs simultaneous to steps 1080 and 1090.

Step 1110 includes deactivating exhaust valve 69 associated with the inlets of the blowdown line 45 when the engine 11 is operated with a BMEP value less than a predetermined threshold. For example, Step 1110 may correspond to deactivating blowdown valves while operating the engine 11 in the low load region 79, where the first predetermined BMEP threshold 87 corresponds to the aforementioned “predetermined threshold”. Such a process of deactivating the blowdown valves in the low load region 79 can be seen in the second row of FIG. 5, where each timing profile has deactivated blowdown valves in the low load region 79. As discussed above, deactivating the blowdown valves forces all exhaust gases to be diverted through the scavenge line 47 to the catalytic conversion device 57. In turn, this causes the exhaust gas temperature at the catalytic conversion device 57 to be increased compared to typical DEB manifolds, which aids in the catalytic conversion process. Thus, an engine 11 configured according to one of the timing profiles as described herein benefits from reduced emissions, among other benefits as discussed above.

Embodiments of the present disclosure may provide at least one of the following advantages. The use of an extended blowdown event results in a catalytic converter receiving higher temperature exhaust gases than typically afforded by DEB manifolds. Such a benefit is further experienced by the deactivation of the scavenge valves, which routes additional exhaust gases towards the catalytic converter. On the other hand, the deactivation of the blowdown valves is particularly beneficial in providing additional torque to the engine by virtue of all exhaust gases being routed to the turbine. Furthermore, by configuring an engine to selectively actuate the associated scavenge and blowdown valves using one of the timing profiles as discussed herein, the engine is configured to provide a balanced torque delivery while retaining emissions compliance in an efficient and simple manner.

Although only a few example embodiments have been described in detail above, those skilled in the art will readily appreciate that many modifications are possible in the example embodiments without materially departing from this invention. For example, although not substantially described herein, an engine may further include an Exhaust Gas Recirculation (EGR) circuit to recycle exhaust gases. In addition, many modifications will be appreciated by those skilled in the art to adapt a particular instrument, situation, or material to embodiments of the disclosure without departing from the essential scope thereof. Accordingly, all such modifications are intended to be included within the scope of this disclosure as defined in the following claims.

Furthermore, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

What is claimed is:

1. An engine, comprising:
a plurality of pistons configured to be actuated by a plurality of combustion reactions, where the combustion reactions create exhaust gases;
a plurality of cylinders, each cylinder being configured to house a corresponding piston of the plurality of pistons and form a containment boundary for a corresponding combustion reaction of the plurality of combustion reactions;
a crankshaft configured to be actuated by the plurality of pistons;
an intake manifold configured to supply a gas mixture to the plurality of cylinders;
a plurality of intake valves that are collectively configured to control a flow rate of the gas mixture from the intake manifold to a corresponding cylinder of the plurality of cylinders;
at least one fuel injector configured to inject fuel into one or more cylinders of the plurality of cylinders, where the fuel is combined with the gas mixture to form a fuel mixture that is combusted in the corresponding cylinder during the corresponding combustion reaction;
an exhaust manifold comprising a blowdown line and a scavenge line, where the blowdown line comprises a plurality of blowdown line inlets that collectively receive a first portion of the exhaust gases from the plurality of cylinders and deliver the first portion of the exhaust gases to a turbine configured to be actuated by the exhaust gases, and the scavenge line comprises a plurality of scavenge line inlets that collectively receive a second portion of the exhaust gases from the plurality of cylinders and deliver the second portion of the exhaust gases to a catalytic conversion device;
a plurality of exhaust valves that are collectively configured to control a flow rate of the exhaust gases passing from a corresponding cylinder of the plurality of cylinders to the exhaust manifold, where each exhaust valve of the plurality of exhaust valves is disposed at an associated blowdown line inlet of the plurality of blowdown line inlets or at an associated scavenge line inlet of the plurality of scavenge line inlets, and
an Electronic Control Unit (ECU) configured to coordinate operations of the plurality of intake valves and the plurality of exhaust valves such that the exhaust valves associated with the blowdown line inlets are deactivated when the engine operates with a Brake Mean Effective Pressure (BMEP) value that is less than a first predetermined BMEP threshold.

2. The engine of claim 1, further comprising:
an intake camshaft configured to actuate the plurality of intake valves, and an exhaust camshaft configured to facilitate the actuation of the exhaust valves associated with the blowdown line inlets and the exhaust valves associated with the scavenge line inlets.

3. The engine of claim 2, wherein the exhaust camshaft is further configured to actuate a plurality of Roller Finger Followers (RFFs), and each RFF of the plurality of RFFs actuates a corresponding exhaust valve of the plurality of exhaust valves.

4. The engine of claim 3, wherein each RFF is formed as a two-step RFF that is controlled to switch between an activated state and a deactivated state based upon a timing profile selected by the ECU.

5. The engine of claim 1, wherein the ECU is further configured to instruct the exhaust valves associated with the blowdown line inlets to activate when a rotation speed of the crankshaft is less than a predetermined engine speed threshold and when the BMEP value is greater than a second predetermined BMEP threshold.

6. The engine of claim 1, wherein the ECU is further configured to instruct the exhaust valves associated with the blowdown line inlets to activate for a period of time encompassing at least 225 degrees of rotation of the crankshaft.

7. The engine of claim 6, wherein the ECU is further configured to instruct the exhaust valves associated with the scavenge line inlets to activate for a portion of the period of time such that the exhaust valves associated with the blowdown line inlets are activated simultaneously to the exhaust valves associated with the scavenge line inlets for the portion of the period of time.

8. The engine of claim 1, wherein the ECU is further configured to instruct the exhaust valves associated with the scavenge line inlets to activate for a period of time encompassing at least 225 degrees of rotation of the crankshaft when the BMEP value is less than the first predetermined BMEP threshold.

9. The engine of claim 1, wherein the ECU is further configured to instruct the exhaust valves associated with the scavenge line inlets to activate when the BMEP value is less than the first predetermined BMEP threshold.

10. The engine of claim 9, wherein the ECU is further configured to instruct the exhaust valves associated with the scavenge line inlets to activate for a period of time encompassing at least 225 degrees of rotation of the crankshaft.

11. The engine of claim 1, wherein the ECU is further configured to instruct the exhaust valves associated with the scavenge line inlets and the exhaust valves associated with the blowdown line inlets to activate when a rotation speed of the crankshaft is greater than a predetermined engine speed threshold and when the BMEP value is greater than a second predetermined BMEP threshold.

12. The engine of claim 1, wherein the ECU is further configured to instruct the exhaust valves associated with the scavenge line inlets and the exhaust valves associated with the blowdown line inlets to activate when the BMEP value is greater than the first predetermined BMEP threshold and less than a second predetermined BMEP threshold.

13. The engine of claim 1, wherein the ECU is further configured to instruct the exhaust valves associated with the scavenge line inlets to deactivate when a rotation speed of the crankshaft is less than a predetermined engine speed threshold and when the BMEP value is greater than a second predetermined BMEP threshold.

14. A method, comprising:
supplying a gas mixture to a plurality of cylinders with an intake manifold;
controlling a flow rate of the gas mixture from the intake manifold to a corresponding cylinder of the plurality of cylinders with a plurality of intake valves;
injecting fuel into one or more cylinders of the plurality of cylinders with at least one fuel injector;
combining the fuel with the gas mixture to form a fuel mixture that is combusted in the corresponding cylinder during a corresponding combustion reaction of a plurality of combustion reactions, where the combustion of the fuel mixture creates exhaust gases;
containing each combustion reaction of the plurality of combustion reactions in the corresponding cylinder of the plurality of cylinders, each cylinder being configured to house a corresponding piston of the plurality of pistons and form a containment boundary for the corresponding combustion reaction;
actuating a plurality of pistons with the plurality of combustion reactions;
actuating a crankshaft with the plurality of pistons;
receiving a first portion of the exhaust gases from the plurality of cylinders and delivering the first portion of the exhaust gases to a turbine configured to be actuated by the exhaust gases with a plurality of blowdown line inlets of a blowdown line of an exhaust manifold;
receiving a second portion of the exhaust gases from the plurality of cylinders and delivering the second portion of the exhaust gases to a catalytic conversion device with a plurality of scavenge line inlets of a scavenge line of the exhaust manifold;
controlling a flow rate of the exhaust gases from the corresponding cylinder of the plurality of cylinders to the exhaust manifold with a plurality of exhaust valves, where each exhaust valve of the plurality of exhaust valves is disposed at an associated blowdown line inlet of the plurality of blowdown line inlets or at an associated scavenge line inlet of the plurality of scavenge line inlets, and
coordinating operations of the plurality of intake valves and the plurality of exhaust valves with an Electronic Control Unit (ECU) such that the exhaust valves associated with the blowdown line inlets are deactivated when an engine comprising the intake valves and the exhaust valves operates with a Brake Mean Effective Pressure (BMEP) value that is less than a first predetermined BMEP threshold.

15. The method of claim 14, further comprising: instructing, with the ECU, the exhaust valves associated with the blowdown line inlets to activate when a rotation speed of the crankshaft is less than a predetermined engine speed threshold and when the BMEP value is greater than a second predetermined BMEP threshold.

16. The method of claim 14, further comprising: instructing, with the ECU, the exhaust valves associated with the scavenge line inlets with the ECU to activate when the BMEP value is less than the first predetermined BMEP threshold.

17. The method of claim 16, further comprising: instructing, with the ECU, the exhaust valves associated with the blowdown line inlets to activate for a period of time encompassing at least 225 degrees of rotation of the crankshaft.

18. The method of claim 14, further comprising: instructing, with the ECU, the exhaust valves associated with the scavenge line inlets and the exhaust valves associated with the blowdown line inlets to activate when a rotation speed of the crankshaft is greater than a predetermined engine speed threshold and when the BMEP value is greater than a second predetermined BMEP threshold.

19. The method of claim 14, further comprising: instructing, with the ECU, the exhaust valves associated with the scavenge line inlets and the exhaust valves associated with the blowdown line inlets to activate when the BMEP value is greater than the first predetermined BMEP threshold and less than a second predetermined BMEP threshold.

20. The method of claim 14, further comprising: instructing, with the ECU, the exhaust valves associated with the scavenge line inlets to deactivate when a rotation speed of the crankshaft is less than a predetermined engine speed threshold and when the BMEP value is greater than a second predetermined BMEP threshold.
